(19) United States
(12) Patent Application Publication
(10) Pub. No.: US 2009/0037440 A1
(43) Pub. Date: Feb. 5, 2009

(54) Streaming Hierarchical Clustering

(76) Inventors: Stefan Will, El Cerrito, CA (US); James Charles Williams, Hawi, HI (US)

Correspondence Address: NORTH WEBER & BAUGH LLP, 2479 E. BAYSHORE ROAD, SUITE 707, PALO ALTO, CA, 94303, US

(21) Appl. No.: 11/830,751

(22) Filed: Jul. 30, 2007

(51) Int. Cl. G06F 17/30

(52) U.S. Cl. 707/100; 707/E17.001

(57) ABSTRACT

Systems, apparatuses, and methods are described for incrementally adding items received from an input stream to a cluster hierarchy. An item, such as a document, may be added to a cluster hierarchy by analyzing both the item and its relationship to the existing cluster hierarchy. In response to this analysis, a cluster hierarchy may be adjusted to provide an improved organization of its data, including the newly added item.

### BACKGROUND

A. Technical Field

The present invention pertains generally to data analysis, and relates more particularly to streaming hierarchical clustering of multi-dimensional data.

B. Background of the Invention

Data mining and information retrieval are examples of applications that access large repositories of data that may or may not change over time. Providing efficient accessibility to such repositories represents a difficult problem. One way this is done is to perform an analysis of common features of the data within a repository in order to organize the data into groups. An example of this type of data analysis is data clustering. Data clustering can be used to organize complex data so that users and applications can access the data efficiently. Complex data contain many features, so each complex data point can be mapped to a position within a multi-dimensional data space in which each dimension of the data space represents a feature.

FIG. 1 is an illustration of a data space 100 in which a group of data points 105 is distributed. Data clustering provides a way to organize data points based on their similarity to each other. Data points that are close together within a data space are more similar to each other than to any data point that is farther away within the same data space. Groupings of closely distributed data points within a data space are called clusters (110a-d). For example, each data point may represent a document. Identifying similarities between data points allows for groups (clusters) of similar documents to be identified within a data space.

The distribution of clusters within a data space may define any of a variety of patterns. A single cluster within a pattern is called a “node.” One example of a cluster distribution pattern is a “flat” distribution pattern in which the nodes form a simple set without internal structure. Another example is a “hierarchical” distribution pattern in which nodes are organized into trees. A tree is created when the set of data points in a cluster node is split into a group of subsets, each of which may be further split recursively. The top level node is called the “root,” its subsets are called its “children” or “child nodes,” and the lowest level nodes are called “leaves” or “leaf nodes.” A hierarchical distribution pattern of clusters is called a “cluster hierarchy.”

FIG. 1 illustrates the application of data clustering analysis to a data space that has already been populated with a full set of data. In this case, distribution patterns within the data space can be discovered and refined through analysis. Because a fully populated set of data is available to be analyzed, distribution patterns and cluster groupings are oftentimes apparent based on the distribution of the data within the complete data set. However, there are application scenarios in which it is difficult to obtain a full set of data before applying data clustering analysis. In these cases, clusters must be discovered and incrementally refined as data is acquired. This creates issues in effectively managing a data space that is changing over time.

### SUMMARY OF THE INVENTION

Systems, apparatuses, and methods are described for incrementally adding items received from an input stream to a cluster hierarchy. An item, such as a document, may be added to a cluster hierarchy by analyzing both the item and its relationship to the existing cluster hierarchy. In response to this analysis, a cluster hierarchy may be adjusted to provide an improved organization of its data, including the newly added item.

Applications such as information retrieval of documents may require access to large repositories of data that may or may not change over time. Data clustering is an analysis method that can be used to organize complex data so that applications can access the data efficiently. Data clustering provides a way to organize similar data into clusters within a data space. Clusters can form a variety of distribution patterns, including hierarchical distribution patterns.

Distribution patterns of clusters can be discovered and refined within a fully populated data space. However, there are application scenarios in which it is difficult to obtain a full set of data before applying data clustering analysis.

Some features and advantages of the invention have been generally described in this summary section; however, additional features, advantages, and embodiments are presented herein or will be apparent to one of ordinary skill in the art in view of the drawings, specification, and claims hereof. Accordingly, it should be understood that the scope of the invention shall not be limited by the particular embodiments disclosed in this summary section.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. (“FIG.”) 1 illustrates data clustering in a multi-dimensional space according to prior art.

FIG. 2 depicts a streaming hierarchical clustering system according to various embodiments of the invention.

FIG. 3 depicts an item classifier system according to various embodiments of the invention.

FIG. 4 depicts a merger system according to various embodiments of the invention.

FIG. 5 depicts a method for adding an input item received from a stream to an existing cluster hierarchy according to various embodiments of the invention.

FIG. 6 depicts a method for applying a merging operation to the set of root child nodes of a cluster hierarchy according to various embodiments of the invention.

FIG. 7 depicts a method for applying a density optimization procedure to a cluster hierarchy according to various embodiments of the invention.

FIG. 8 depicts a method for adding an input document received from a stream to an existing cluster hierarchy according to various embodiments of the invention.

### DETAILED DESCRIPTION OF THE PREFERRED EMBODIMENTS

Systems, apparatuses, and methods are described for incrementally adding items received from an input stream to a cluster hierarchy. An item, such as a document, may be added to a cluster hierarchy by analyzing both the item and its relationship to the existing cluster hierarchy. In response to this analysis, a cluster hierarchy may be adjusted to provide an improved organization of its data, including the newly added item.

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be performed in a variety of mediums, including software, hardware, or firmware, or a combination thereof. Accordingly, the flow charts described below are illustrative of specific embodiments of the invention and are meant to avoid obscuring the invention.

Reference in the specification to “one embodiment,” “preferred embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

In various embodiments of the invention, documents received in a stream are classified into a cluster hierarchy in order to facilitate information retrieval. Each document is described in terms of features derived from its text contents. The cluster hierarchy may be adjusted as successive new documents from the stream are added.

A. System Implementations

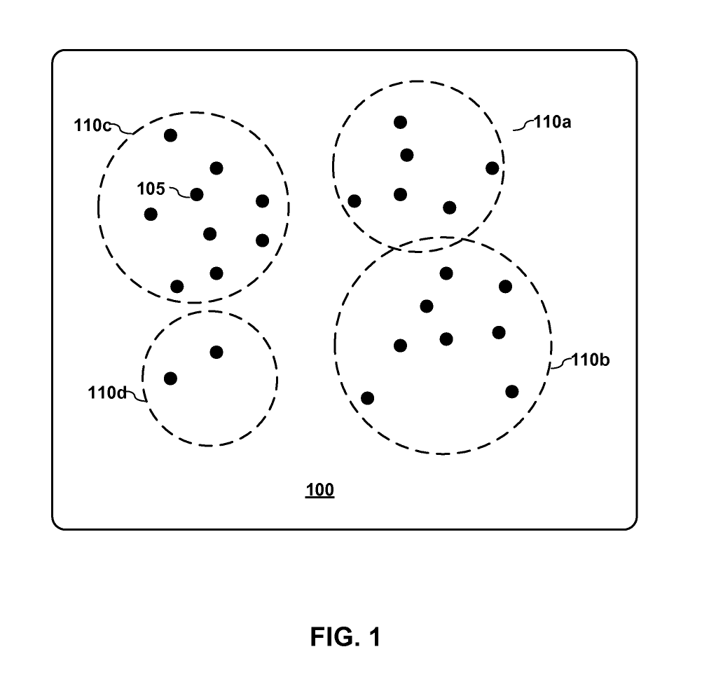

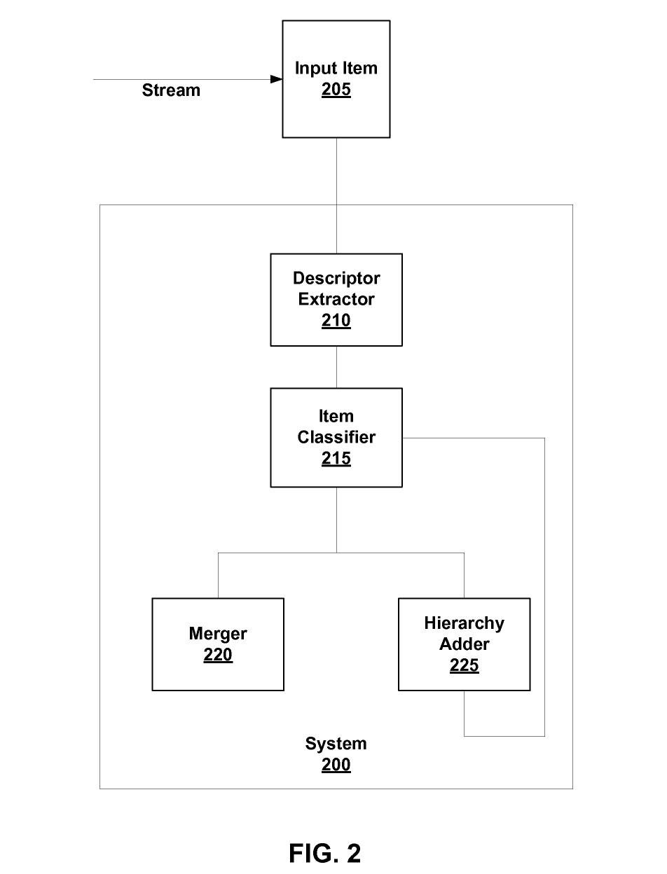

FIG. 2 depicts a system 200 for incrementally adding items received from an input stream to a cluster hierarchy according to various embodiments of the invention. System 200 comprises a descriptor extractor 210, an item classifier 215, a merger 220, and a hierarchy adder 225.

In various embodiments, descriptor extractor 210 receives an input item 205 and extracts at least one descriptor from it in order to generate an item descriptor. In various embodiments, the input item 205 is a document for which descriptors are text features and the descriptor extractor 210 generates a feature vector. For example, the text features may be frequencies of terms used within the document. One skilled in the art will recognize that “stop words” such as “a,” “an,” and “the” may be filtered out before those frequencies are calculated. In alternative embodiments, the terms may be limited to specific linguistic constructs such as, for example, nouns or noun phrases.

These term frequency values may be weighted using methods known by those skilled in the art, for example the method called “tf-idf” (term frequency-inverse document frequency). The term frequency (“tf”) is the number of times a term appears in a document while the inverse document frequency (“idf”) is a measure of the general importance of the term (obtained by dividing the number of all documents by the number of documents containing the term). Each term is given a weighting, or score, by dividing its tf by its idf. Those skilled in the art will recognize that there are many methods for applying tf-idf weighting to terms. In various embodiments, log scaling may be applied to tf and/or idf values in order to mitigate effects of terms used commonly in all documents. Log scaling spreads out the distribution of frequency values by reducing the effect of very high frequency values

A cluster “label” may be created from the feature vector defining the cluster center. The label is a vector which is a set of at least one text term feature used frequently within the documents within the cluster but used infrequently within other documents within the document vector space. The cluster label enables identification of a cluster in terms of a set of its key features. One skilled in the art will recognize that there are many possible variations of labeling methods.

In various embodiments, an item classifier 215 receives an item descriptor 305 from the descriptor extractor 210 and classifies the item descriptor based on its relationship to the root child cluster nodes in a cluster hierarchy. The item classifier 215 compares the item descriptor to each of the root child cluster nodes to identify an appropriate root child for to which to assign the descriptor extractor 210. If an appropriate root child is not identified, a new root child is created and the new item descriptor 210 is assigned to the new root child.

In various embodiments, a merger 220 receives a set of root child cluster nodes and creates an additional layer in at least one subtree of a cluster hierarchy. The merger 220 enables the hierarchy to grow by adding depth (the additional layer) when a limit to growth by breadth (adding to the root child nodes) is reached.

In various embodiments, a hierarchy adder 225 receives a set of root child cluster nodes, an item descriptor, and a selected root child cluster from the item classifier 215, and adds the item descriptor to the selected root child cluster. The hierarchy adder 225 may then recursively invoke the item classifier 215 to add the item descriptor to the children of the selected root child cluster, treating the selected root child cluster as the root of the subtree below it.

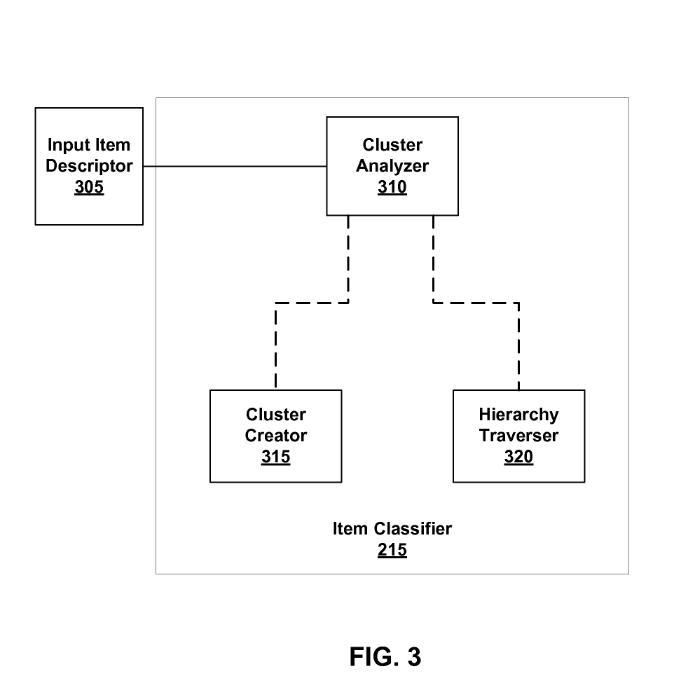

FIG. 3 depicts an item classifier 215 which may receive an input item descriptor 305 and classify the item descriptor 305 based on its relationship to the root child clusters in an existing hierarchy according to various embodiments. The item classifier 215 comprises a cluster analyzer 310, a cluster creator 315, and a hierarchy traverser 320.

In various embodiments, the cluster analyzer 310 applies a decision function to the input item descriptor 305 and a descriptor defining at least one cluster center in data space in order to determine if the input item descriptor 305 is sufficiently similar to the cluster center descriptor to be assigned to that cluster. If a text term feature vector is an input item descriptor 305, the input feature vector is compared with a feature vector of the center of at least one root child cluster in vector space and the decision function may test whether the input feature vector falls within the radius of the root child cluster that has the closest center descriptor in vector space. The result of the decision function determines whether the input item descriptor 305 is sent to the cluster creator 315 or to the hierarchy traverser 320. If the item descriptor 305 can be added to at least one root child cluster in data space (classified into the cluster), it is sent to the hierarchy traverser 320. Otherwise, the item descriptor 305 is sent to the cluster creator 315.

The hierarchy traverser 320 receives the item descriptor 305 and adds the item descriptor to the data space, assigning it to the existing root child cluster into which it has been classified. The existing cluster then is assigned the role of current root within the cluster hierarchy, and the item descriptor 305 and the set of current root child nodes are provided to the hierarchy adder 225.

In various embodiments, the hierarchy adder 225 receives the item descriptor 305 from the hierarchy traverser 320 within the item classifier system 215. The hierarchy adder sends the item descriptor 305 to the item classifier 215 for processing using the current root. In various embodiments, the output of the hierarchy adder 225 may be an addition of an item descriptor 305 to at least one set of child nodes in at least one subtree of an existing cluster hierarchy.

The cluster creator 315 may receive the item descriptor 305 from the cluster analyzer and generate a cluster in data space. The item descriptor 305 is assigned to be the cluster center, and the new cluster is added to the set of root child cluster nodes. The cluster creator 315 applies a threshold function to the set of root child cluster nodes in order to determine if the size of the incremented set of root child cluster nodes has exceeded the threshold. If the threshold size is exceeded, the item descriptor 315 and the incremented set of root child cluster nodes are provided to the merger 220.

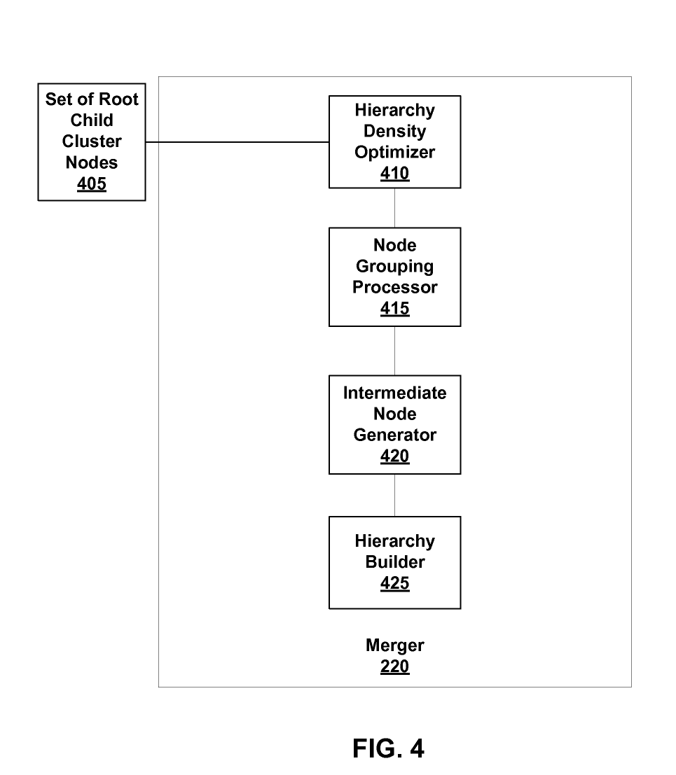

FIG. 4 depicts a merger 220 which may receive a set of root child cluster nodes 405 from the cluster creator 315 according to various embodiments. The merger 220 comprises a hierarchy density optimizer 410, a node grouping processor 415, an intermediate node generator 420, and a hierarchy builder 425.

In various embodiments, the hierarchy density optimizer 410 is provided with a set of root child cluster nodes 405 that have exceeded the size threshold applied by the cluster creator 315. The hierarchy density optimizer 410 applies a threshold function to the set of root child cluster nodes, and if the size of at least one node in the set is found to exceed the threshold, a density optimization procedure is applied to the set of nodes in order to improve sampling in denser areas of the data space. This density optimization procedure generates an improved (in terms of density distribution) set of root child cluster nodes. In various embodiments, the density optimization procedure employs recursive replacement of nodes with their children.

The node grouping processor 415 receives a set of root child nodes and applies a batch clustering procedure to the nodes in the set in order to find groups of similar nodes. In various embodiments, a K-Means batch clustering procedure may be used, although one skilled in the art will recognize that numerous other clustering procedures may be used within the scope and spirit of the present invention.

The intermediate node generator 420 is provided with a grouped set of root child nodes by the node grouping processor 415. An “intermediate node” is a cluster node based on at least one common feature of a subset of the root child nodes. At least one intermediate node is created based upon an analysis of the grouped set of root child nodes. One embodiment may create an intermediate node for each group identified by the node grouping processor 415 that contains more than one node.

The hierarchy builder 425 is provided with a grouped set of root child nodes and at least one intermediate node created from an analysis of the set by an intermediate node generator 420. The grouped set of root child nodes is re-assigned to intermediate nodes based on similarity. One embodiment may assign each root child node to the intermediate node corresponding to the group that contains the root child node. The intermediate nodes are assigned to be child nodes of the root. This reduces the number of root children and creates an additional layer in the cluster hierarchy.

B. Method for Adding a Received Item from a Stream to a Cluster Hierarchy

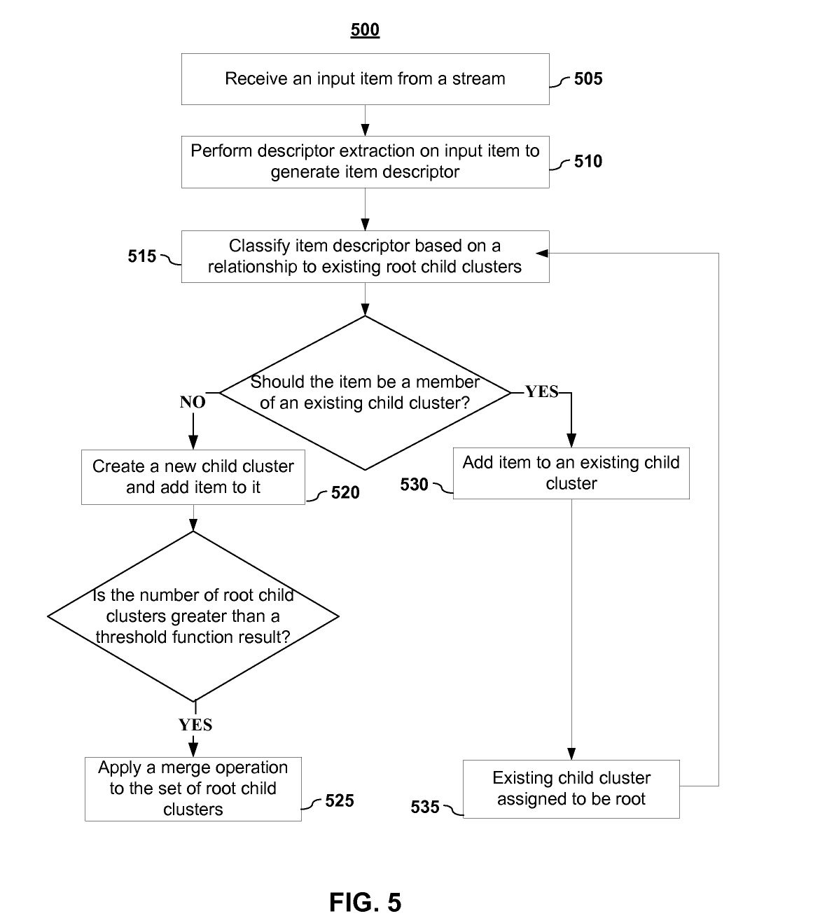

FIG. 5 depicts a method 500, independent of structure, to add an item received from a stream (“input item”) (step 505) to a cluster hierarchy according to various embodiments of the invention. In step 510, at least one descriptor is extracted from the input item and used to generate an item descriptor. The descriptors comprising the item descriptor correspond to the dimensions of the data space into which the item will be inserted. In various embodiments, an item descriptor is a feature vector that has been generated after feature extraction is applied to the input item. One skilled in the art will recognize that numerous different descriptor extraction methods may be used within the scope and spirit of the present invention.

In step 515, the input item is classified according to the relationship between the item descriptor and the root child clusters (nodes) in the current cluster hierarchy. In various embodiments, “classification” means that a decision function based on similarity between the item descriptor and each root child cluster node is applied and that the result determines whether or not the input item can be assigned to one of the root child clusters.

If the input item can be classified into one of the existing root child clusters, its item descriptor is assigned to that cluster and added to the data space (step 530). In step 535, the item descriptor then is added to the child nodes of that cluster by executing step 515 after assigning that cluster the role of root.

If the input item cannot be classified into one of the existing root child clusters or if there are no existing root child clusters, a new root child cluster is created and the input item descriptor is assigned to the new child cluster (step 520). A threshold function is applied to the set of root child clusters to determine if the set size has exceeded a threshold. If the set size has exceeded a threshold, an embodiment of a “merge operation” 600 is applied to the set of root child clusters.

1. Merge Operation Method

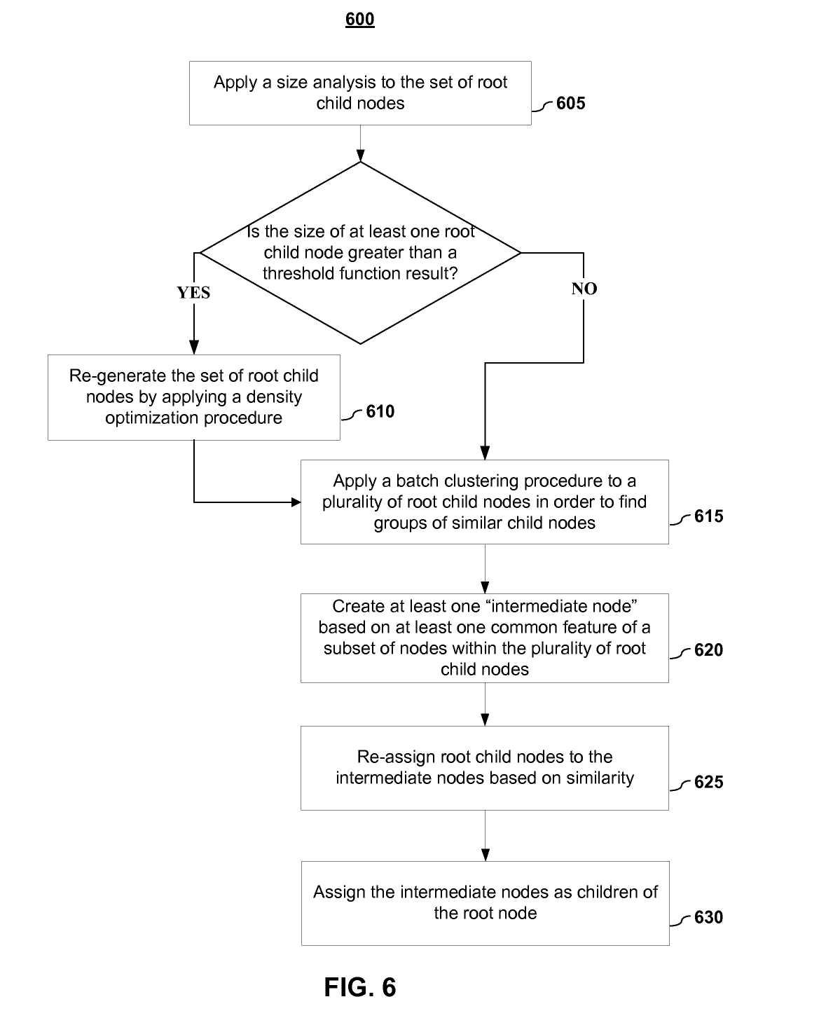

FIG. 6 depicts various embodiments of a method 600, independent of structure, to apply a “merge operation” to a set of root child nodes. A “merge operation” (or “merge”) will reduce the number of root child nodes in the set and add at least one level to the cluster hierarchy. In step 605, a size analysis is applied to the provided set of root child nodes. In various embodiments, the size analysis applies a threshold function to the set of nodes in order to determine if at least one root child node in the set has a size that exceeds the threshold. If at least one root child node has a size that exceeds the threshold, a “density optimization procedure” 700 is applied to the set of root child nodes in order to generate a set of nodes with an adjusted density distribution (step 610). Node sets with an optimized density distribution enable improved sampling in denser areas of the data space.

In step 615, a “batch” clustering procedure may be applied to a set of root child nodes in order to find groups (subsets) of similar nodes. The clustering procedure is called “batch” because it is being applied to an existing set of data. In various embodiments, a K-Means procedure is applied but one skilled in the art will recognize that numerous different procedures may be used.

In step 620, at least one “intermediate node” is created. An “intermediate node” is a cluster node based on at least one common feature of a subset of the root child nodes. In step 625, at least one grouped set of root child nodes is re-assigned as children of an intermediate node based on similarity. In step 630, the intermediate nodes created in step 620 are added to the set of root child nodes. In one embodiment, an intermediate node is created for each group found by the batch clustering procedure applied in step 615 that contains more than one node, and the nodes in each group are assigned as children of the group's intermediate node.

2. Density Optimization Method

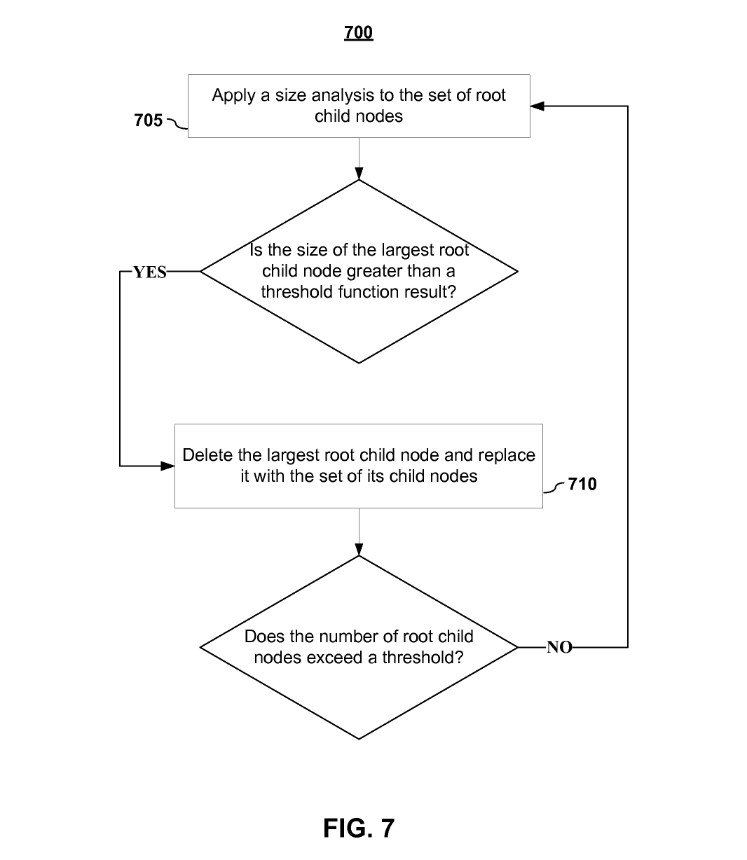

FIG. 7 depicts various embodiments of a method 700, independent of structure, to apply density optimization to a set of root child cluster nodes. In step 705, a size threshold analysis is applied to the set of root child nodes in order to determine if the largest node in the set has a size that exceeds the threshold.

In some embodiments, a size threshold function may compare the size of the largest node in the set to the size of the next largest node in the set. If the size of the largest node exceeds a threshold, then the node is deleted from the set of root child nodes and replaced with the set of its child nodes (step 710). A threshold analysis then is applied to the adjusted set of root child nodes in order to determine if the set size exceeds a threshold. If the set size does not exceed a threshold, step 705 is applied to the adjusted set of root child nodes.

In various embodiments, method 700 will result in recursive replacement of nodes with their children.

C. Method for Adding a Received Document from a Stream to a Cluster Hierarchy

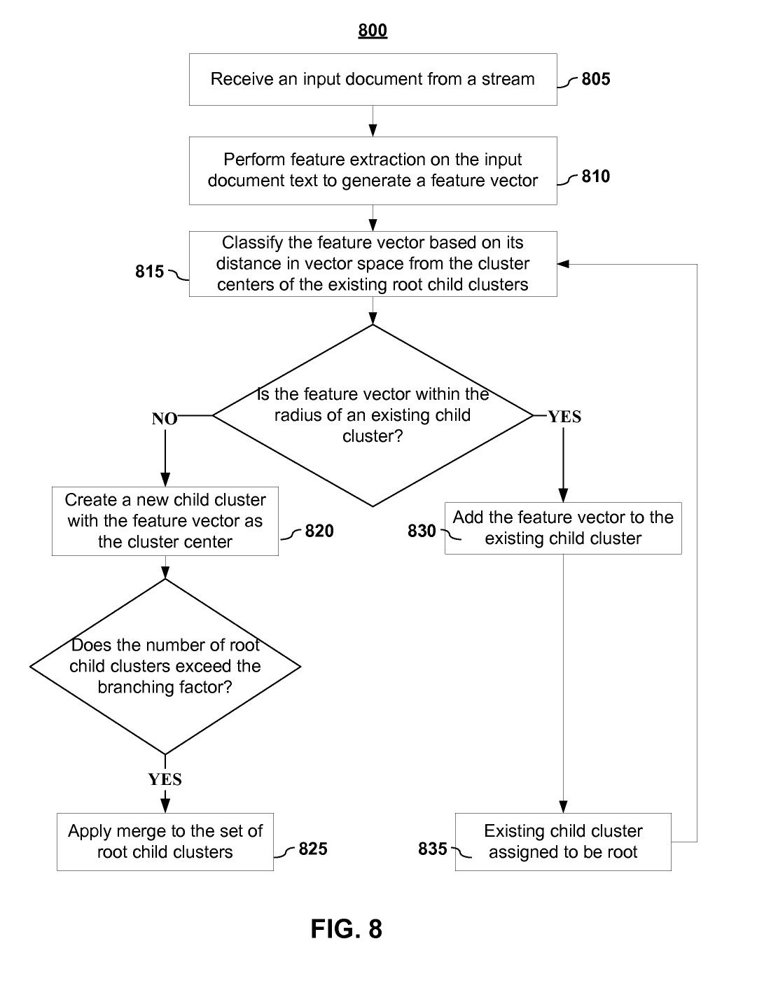

FIG. 8 depicts a method 800, independent of structure, to add a document received from a stream (“input document”) (step 805) to a cluster hierarchy according to specific embodiments of the invention. In step 810, at least one text feature is extracted from the input document and used to generate a feature vector. Each document is represented by the location of its feature vector in vector space. For example, text features may be frequencies of terms used within the document. One skilled in the art will recognize that “stop words” such as “a,” “an,” and “the” may be filtered out before those frequencies are calculated. In alternative embodiments, the terms may be limited to specific linguistic constructs such as, for example, nouns or noun phrases.

These term frequency values may be weighted using methods known by those skilled in the art, for example the method called “tf-idf” (term frequency-inverse document frequency). The term frequency (“tf”) is the number of times a term appears in a document while the inverse document frequency (“idf”) is a measure of the general importance of the term (obtained by dividing the number of all documents by the number of documents containing the term). Each term is given a weighting, or score, by dividing its tf by its idf. Those skilled in the art will recognize that there are many methods for applying tf-idf weighting to terms. In various embodiments, log scaling may be applied to tf and/or idf values in order to mitigate effects of terms used commonly in all documents. Log scaling spreads out the distribution of frequency values by reducing the effect of very high frequency values.

A cluster “label” may be created from the feature vector defining the cluster center. The label is a vector which is a set of at least one text term feature used frequently within the documents within the cluster but used infrequently within other documents within the document vector space. The cluster label enables identification of a cluster in terms of a set of its key features. One skilled in the art will recognize that there are many possible variations of labeling methods.

In step 815, the input document is classified according to the relationship between its feature vector and the root child clusters (nodes) in the current cluster hierarchy. Each cluster is described by a feature vector representing its center plus a radius representing the distance of vector space spanned by the cluster. In various embodiments, “classification” measures the distance between the input document feature vector and the cluster center feature vector plus determines if the input document feature vector is located in vector space within the cluster's radius.

If the input document can be classified into one of the existing root child clusters, its feature vector is assigned to that cluster and added to the vector space (step 830). The center of the cluster to which the input document has been assigned may be updated, for example by incrementally maintaining the average of the feature vectors used by each document assigned to the cluster, or by determining a single document within the cluster that best represents the center, or by using alternative techniques that will be apparent to one skilled in the art. In step 835, the feature vector then is added to the child nodes of that cluster by executing step 815 after assigning that cluster the role of root.

If the input item cannot be classified into one of the existing root child clusters or if there are no existing root child clusters, a new root child cluster is created and the input document feature vector is assigned to be the center of the new child cluster (step 820). A threshold function is applied to the set of root child clusters to determine if the set size has exceeded a threshold. If the set size has exceeded a threshold, an embodiment of a “merge operation” 600 is applied to the set of root child clusters.

Aspects of the present invention may be implemented in any device or system capable of processing data, including without limitation, a general-purpose computer and a specific computer, server, or computing device.

It shall be noted that embodiments of the present invention may further relate to computer products with a computer-readable medium that have computer code thereon for performing various computer-implemented operations. The media and computer code may be those specially designed and constructed for the purposes of the present invention, or they may be of the kind known or available to those having skill in the relevant arts. Examples of computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter.

While the invention is susceptible to various modifications and alternative forms, specific examples thereof have been shown in the drawings and are herein described in detail. It should be understood, however, that the invention is not to be limited to the particular forms disclosed, but to the contrary, the invention is to cover all modifications, equivalents, and alternatives falling within the scope of the appended claims.

We claim:

1. A method for incrementally adding an item received from an input stream to a cluster hierarchy, the method comprising:
generating an item descriptor based on at least one characteristic of the item;
classifying the item descriptor by analyzing the at least one characteristic of the item relative to the cluster hierarchy;
adding the item to a cluster node, within the cluster hierarchy, according to the classified item descriptor; and
updating the cluster hierarchy based on an analysis of structure of the cluster hierarchy and a relationship of the item to the structure.

2. The method of claim 1 wherein classifying the item descriptor comprises determining if the item descriptor should be added to a child cluster within the cluster hierarchy.

3. The method of claim 1 wherein updating the cluster hierarchy comprises adding the item descriptor to at least one set of child nodes in at least one subtree of the cluster hierarchy.

4. The method of claim 3 wherein adding the item descriptor to the at least one set of child nodes in the at least one subtree comprises:
adding the item descriptor to the child cluster of the at least one subtree;
assigning the child cluster as current root; and
determining if the item descriptor should be added to a child cluster of the current root.

5. The method of claim 1 wherein the step of updating the cluster hierarchy comprises creating an additional layer in at least one subtree of the cluster hierarchy.

6. The method of claim 5 wherein the step of creating the additional layer in the at least one subtree of the cluster hierarchy comprises:
applying a clustering procedure to a subset within a set of child cluster nodes;
creating at least one intermediate node based on at least one common feature of the subset of the child cluster nodes;
assigning at least one child cluster node, within the set of child cluster nodes, to the at least one intermediate node; and
adding the at least one intermediate node to the set of child cluster nodes.

7. The method of claim 6 further comprising the step of applying a hierarchy density optimizing procedure to the set of child cluster nodes within the cluster hierarchy.

8. The method of claim 7 wherein applying the hierarchy density optimizing procedure to the set of child cluster nodes comprises:
determining if a size of a first largest child cluster node exceeds a first threshold; and
deleting the first largest child cluster node and replacing the first largest child cluster node with its first child cluster nodes when the size of the first largest child cluster node exceeds the first threshold; and
recursively deleting a second largest child cluster node and replacing the second largest child node with its second child cluster nodes if a total number of cluster nodes within the set of cluster nodes is below a second threshold.

9. The method of claim 8 wherein the first threshold is a density value.

10. The method of claim 8 wherein the second threshold is a number of cluster nodes.

11. A computer readable medium having instructions for performing the method of claim 1.

12. A system for incrementally adding an item received from an input stream to a cluster hierarchy, the system comprising:
a descriptor extractor, coupled to receive the item from the input stream, that generates an item descriptor based on at least one characteristic of the item;
an item classifier, coupled to receive the item descriptor, that classifies the item descriptor by analyzing the at least one characteristic of the item relative to the cluster hierarchy;
a hierarchy adder, coupled to communicate with the item classifier, that adds the item to a cluster node and its subtree, within the cluster hierarchy, according to the classified item descriptor; and
a merger, coupled to receive the item descriptor and a set of root child nodes, that updates the cluster hierarchy based on an analysis of at least one cluster node within the set of child nodes.

13. The system of claim 12 wherein the merger creates an additional layer in at least one subtree of the cluster hierarchy.

14. The system of claim 12 wherein the item classifier comprises:
a cluster analyzer, coupled to receive the item descriptor, that classifies the item descriptor; and
a cluster creator, coupled to receive the item descriptor, that creates a new child cluster within the cluster hierarchy and adds the item descriptor to the new child cluster.

15. The system of claim 12 wherein the item classifier comprises:
a cluster analyzer, coupled to receive the item descriptor, that classifies the item descriptor; and
a hierarchy traverser, coupled to receive the item descriptor, that analyzes a plurality of layers of the subtree, within the hierarchy cluster, in order to identify the cluster node to which the item is added.

16. An apparatus for creating an additional layer in at least one subtree of a cluster hierarchy, the apparatus comprising:
a node grouping processor, coupled to receive a set of child cluster nodes, that adjusts a distribution of cluster nodes within the set of child cluster nodes based on a feature analysis of the cluster nodes within the set of child cluster nodes;
an intermediate node generator, coupled to receive the set of child cluster nodes, that creates at least one intermediate node based on at least one common feature of a subset of the child cluster nodes; and
a hierarchy builder, coupled to receive the at least one intermediate node and the set of child cluster nodes, that re-assigns at least one child cluster node, within the subset of root child cluster nodes, to the at least one intermediate node and adds the at least one intermediate node to the set of child cluster nodes.

17. The apparatus of claim 16 wherein the feature analysis relates to proximate distances between cluster centers within the set of child cluster nodes.

18. The apparatus of claim 16, further comprising a hierarchy density optimizer, coupled to receive the set of child cluster nodes, that adjusts a number of cluster nodes within the set of child cluster nodes based on a density characteristic of at least one cluster node within the set of child cluster nodes.

19. The apparatus of claim 18 wherein the density characteristic relates to a total number of items within the cluster and its subtree.

20. A method for incrementally adding a document received from an input stream to a cluster hierarchy, the method comprising:
generating a feature vector based on at least one textual characteristic of the document;
classifying the feature vector by analyzing the at least one textual characteristic of the document relative to the cluster hierarchy;
adding the document to a cluster node, within the cluster hierarchy, according to the classified feature vector; and
updating the cluster hierarchy based on an analysis of structure of the cluster hierarchy and a relationship of the document to the structure.

21. The method of claim 20 wherein the feature vector comprises a set of text features extracted from the document.

22. The method of claim 20 wherein the feature vector comprises a set of frequencies of text terms extracted from the document.

23. The method of claim 22 wherein log scaling is applied to the frequencies of text terms extracted from the document to smooth a distribution of features within a particular feature vector.

24. The method of claim 20 wherein classifying the feature vector comprises determining if the feature vector should be added to an existing child cluster within the cluster hierarchy.

25. The method of claim 24 further comprising adding the feature vector to the existing child cluster if the feature vector is within a threshold distance from a cluster feature vector representing the existing child cluster center.

26. The method of claim 24 further comprising adding the feature vector to the existing child cluster if a position of the feature vector in the cluster hierarchy is within a radius of the existing child cluster.

27. The method of claim 20 wherein updating the cluster hierarchy comprises adding the feature vector to at least one set of child nodes in at least one subtree of the cluster hierarchy.

28. The method of claim 27 wherein adding the feature vector to the at least one set of child nodes in the at least one subtree comprises:
creating a new child cluster, within the cluster hierarchy, if the feature vector is not added to the existing root child cluster; and
adding the feature vector to the new child cluster.

29. The method of claim 28 wherein the center feature vector is adjusted as the new child cluster is added within the cluster hierarchy.

30. The method of claim 29 wherein a label, associated with the feature vector, is adjusted in response to the new child cluster being added.

31. The method of claim 28 wherein creating the new child cluster comprises:
assigning the feature vector to be a center feature vector associated with the new child cluster; and
creating a label for the new child cluster based on the center feature vector.

32. The method of claim 31 wherein creating the label for the new child cluster comprises creating a label vector from a set of identified relevant features within the center feature vector.

33. The method of claim 20 wherein updating the cluster hierarchy comprises creating an additional layer in at least one subtree of the cluster hierarchy.

34. A computer readable medium having instructions for performing the method of claim 20.

35. A system for incrementally adding a document received from an input stream to a cluster hierarchy, the system comprising:
a descriptor extractor, coupled to receive the document, that generates a feature vector based on at least one textual characteristic of the document;
an item classifier, coupled to receive the feature vector, that classifies the feature vector by analyzing the at least one textual characteristic of the document relative to the cluster hierarchy; and
a hierarchy adder, coupled to communicate with the item classifier, that adds the document to a cluster node and its subtree, within the cluster hierarchy, according to the classified item descriptor; and
a merger, coupled to receive the item descriptor and a set of child nodes, that updates the cluster hierarchy based on a density analysis of at least one cluster node within the set of child nodes.

36. The system of claim 35 wherein the merger creates an additional layer in the subtree of the cluster hierarchy.

37. The system of claim 35 wherein the item classifier comprises:
a cluster analyzer, coupled to receive the feature vector, that classifies the feature vector relative to the cluster hierarchy; and
a cluster creator, coupled to receive the feature vector, that creates a new child cluster within the cluster hierarchy and adds the feature vector to the new child cluster.

38. The system of claim 35 wherein the item classifier comprises:
a cluster analyzer, coupled to receive the feature vector, that classifies the feature vector relative to the cluster hierarchy; and
a hierarchy traverser, coupled to receive the feature vector, that analyzes a plurality of layers of the subtree, within the hierarchy cluster, in order to identify the cluster node to which the item is added.

39. The system of claim 35 wherein the merger further comprises:
a node grouping processor, coupled to receive a set of child cluster nodes, that adjusts a distribution of cluster nodes within the set of child cluster nodes based on a feature analysis of the cluster nodes within the set of child cluster nodes;
an intermediate node generator, coupled to receive the set of child cluster nodes, that creates at least one intermediate node based on at least one common feature of a subset of the child cluster nodes; and
a hierarchy builder, coupled to receive the at least one intermediate node and the set of child cluster nodes, that re-assigns at least one child cluster node, within the subset of child cluster nodes, to the at least one intermediate node and adds the at least one intermediate node to the set of child cluster nodes.

40. The system of claim 39 wherein the merger further comprises a hierarchy density optimizer, coupled to receive the set of child cluster nodes, that adjusts a number of cluster nodes within the set of child cluster nodes based on a density characteristic of at least one cluster node within the set of child cluster nodes.

41. The system of claim 40 wherein the density characteristic relates to a total number of items within the cluster and its subtree.

42. The system of claim 39 wherein the feature analysis relates to proximate distances between cluster centers within the set of child cluster nodes.
